(19) United States
(12) Patent Application Publication
(10) Pub. No.: US 2024/0132379 A1
(43) Pub. Date: Apr. 25, 2024

(54) PRODUCED WATER TREATMENT FOR DIRECT INJECTION USING MECHANICALLY ASSISTED FORWARD OSMOSIS

(71) Applicant: Saudi Arabian Oil Company, Dhahran (SA)

(72) Inventors: Seung-Hak Choi, Incheon (KR); Mohamed Ahmed Soliman, Ras Tanura (SA); Youngchul Choi, Dhahran (SA); Hasan Al Abdulgader, Dammam (SA)

(21) Appl. No.: 18/048,608

(22) Filed: Oct. 20, 2022

(51) Int. Cl. C02F 1/44; C02F 1/20; C02F 1/26; C02F 1/64

(52) U.S. Cl. CPC C02F 1/445; C02F 1/20; C02F 1/265; C02F 1/64; C02F 2101/203

(57) ABSTRACT

The disclosure relates to a method including pre-treating a high salinity aqueous liquid to remove solids, oils, and dissolved gases; using the pre-treated aqueous liquid as a draw solution for mechanically assisted forward osmosis to produce an injection water; and injecting the injection water into an underground formation. The high salinity aqueous liquid includes produced water or ground water. The draw solution is diluted with a feed solution wherein the feed solution has a lower osmotic pressure than the high salinity aqueous liquid.

### FIELD

The disclosure relates to methods to produce injection water from highly saline aqueous liquids, such as produced water or ground water from an oil and gas production site.

### BACKGROUND

The oil and gas industry consumes and produces water at the same time. Water is used to drill and hydraulically fracture wells, maintain production pressure in oil reservoirs, and in oil and gas processing facilities. The required quality of water varies depends on the use and often locally sourced from groundwater, rivers, or lakes. Where fresh water is in high demand for other uses, water reuse and alternative water sources are attractive options. Water is naturally existing in the rocks that contain oil and gas and is extracted along with the oil and gas. This water is commonly called “produced water”. Produced water that has a high quantity of dissolved salt contents is known as brine. In many cases, the brine contains other components such as grease and oil, dispersed oil, suspended solids, heavy metals, organic compounds, dissolved gases and bacteria, chemicals or additives used in products such as scale and corrosion inhibitors, biocides, and emulsion breakers. In addition, produced water may also carry toxic substances such as hydrogen sulfide (H₂S). The most common way of dealing with produced water is to dispose it in deep disposal wells or evaporation ponds. The disposal cost, which includes transportation cost, capital cost and infrastructure maintenance cost, may be as much as $4.00/bbl.

Reuse of produced water can significantly save the natural water resources and minimize environmental impact of the produced water besides the saving of disposal costs. However, the produced water needs to be properly treated in order to meet the requirements for various demands.

### SUMMARY

The disclosure relates to methods to produce injection water from high salinity aqueous liquids, such as produced water or ground water. The high salinity aqueous liquid is treated and the salinity is reduced through the use of an energy efficient mechanically assisted vibrational osmosis system, such as a Vibration Assisted Forward Osmosis (VAFO) system. In the method, the high salinity aqueous liquid passes through a pre-treatment process, forward osmosis (FO) process, and optional post-treatment processes to ensure compatibility of produced water for injection. In the FO process, any low salinity water source (e.g. wastewater, seawater, brackish water, ground water, etc.) which is available in the site can be used as a feed solution, as long as the osmotic pressure is lower than that of the high salinity aqueous liquid. Due to the osmotic pressure difference between the feed solution and the high salinity aqueous liquid, water penetrates through the semi-permeable membranes. Finally, the diluted high salinity aqueous liquid can be directly reused as an injection water without disposal (zero discharge). The method of the invention can minimize or eliminate the disposal cost of produced water by reusing it, lower the cost of and minimize water resources related to injection for pressure maintenance, and lower the cost related to drilling, pumping and injecting conventional injection water.

The disclosure provides a method, including pre-treating a high salinity aqueous liquid to remove solids, oil, and dissolved gases, wherein the high salinity aqueous liquid comprises produced water or ground water; using the pre-treated aqueous liquid as a draw solution for mechanically assisted forward osmosis to produce an injection water, wherein the draw solution is diluted with a feed solution, wherein the feed solution has a lower osmotic pressure than the high salinity aqueous liquid; and injecting the injection water into an underground formation.

In some embodiments, the pre-treated aqueous liquid has a mean suspended particle size of less than or equal to 5 micron. In some embodiments, the pre-treated aqueous liquid has a mean suspended solid particle size of less than or equal to 2 micron.

In some embodiments, the mechanically assisted forward osmosis is vibration assisted forward osmosis or turbulence assisted forward osmosis. In some embodiments, the mechanically assisted forward osmosis is vibration assisted forward osmosis.

In some embodiments, the high salinity aqueous liquid includes produced water. In some embodiments, the pre-treating comprises treating the produced water with one or more of a De-sanding Hydrocyclone, a De-oiling Hydrocyclone, a Dissolved Gas Floatation (DGF) system, an Induced Gas Flotation (IGF) system, a Fine De-sanding Hydrocyclone, a Backwash Filter, a Nutshell Filter, a Multimedia Filter, CPI, Membranes, Centrifuge, FWKO, and CFU.

In some embodiments, the pre-treated aqueous liquid has an oil-in-water content of less than 20 ppm (wt. %), and a total oil and suspended solids of less than 50 ppm.

In some embodiments, the high salinity aqueous liquid comprises ground water.

In some embodiments, the pre-treating the high salinity aqueous liquid includes degassing, iron removal, and filtering.

In some embodiments, the pre-treating the high salinity aqueous liquid further includes dissolved oxygen removal.

In some embodiments, dissolved oxygen is removed from the injection water prior to the injecting.

In some embodiments, the injection water has a mean suspended solid particle size of less than 2 micron, a dissolved oxygen content of less than 0.1 ppm, and an iron content of less than 2 ppm.

In some embodiments, the feed solution comprises wastewater, brackish water, ground water, or a mixture thereof.

In some embodiments, the mechanically assisted forward osmosis utilizes a membrane having a planar geometry or a tubular geometry.

In some embodiments, the mechanically assisted forward osmosis utilizes a membrane material including fully crosslinked aromatic polyamide, aquaporin, cellulose-based acetate, polybenzimidazole, polyoxadiazole, polyfurane, polyether-polyfurane, sulfonated polysulfone, polyvinylamine, polypiperazine-amide, or polypyrrolidine. In some embodiments, the fully crosslinked aromatic polyamide is a thin film composite prepared by an interfacial polymerization technique.

In some embodiments, the method further includes passing the pre-treated liquid through a membrane process to produce desalinated water. In some embodiments, the membrane process includes micro-filtration, ultra-filtration, nano-filtration, reverse osmosis, or ultrahigh pressure reverse osmosis.

In some embodiments, the injecting is performed directly after the mechanically assisted forward osmosis.

### BRIEF DESCRIPTION OF THE FIGURES

FIG. 1 is a flow diagram for a method.

FIG. 2 is a flow diagram for a pre-treatment process.

FIG. 3 is a flow diagram for a method.

FIG. 4 is a flow diagram for a method.

FIG. 5 is a flow diagram for a pre-treatment process.

FIG. 6 is a flow diagram for a pre-treatment process.

FIG. 7 depicts a forward osmosis process.

### DETAILED DESCRIPTION

Unless otherwise defined, all technical and scientific terms used in this document have the same meaning as commonly understood by one of ordinary skill in the art to which the present application belongs.

As used in this disclosure, the term “produced water” can refer to water that is naturally existing in the rocks that contain oil and gas and is extracted along with the oil and gas.

As used in this disclosure, the term “ground water” can refer to any water extracted from or below the Earth's surface. For example, ground water includes aquifer water.

As used in this disclosure the term “mechanically assisted forward osmosis” (MAFO) can refer to a forward osmosis (FO) process that utilizes mechanical assistance to generate shear stress on the membrane surface in order to minimize fouling and concentration polarization. Forward osmosis (FO) is a process to extract fresh water from various feed resources. When a semi-permeable membrane is placed between two solutions which have different osmotic pressure, solvent (e.g. water) flows to equalize the solute concentration. The liquid with a lower osmotic pressure is referred to as the feed solution and the liquid with higher osmotic pressure is referred to as the draw solution. The solvent flows from feed solution to draw solution. FO occurs at room temperature without the need to apply pressure. The only external energy used is that required to overcome the frictional resistance on both sides of the membrane.

Mechanically assisted forward osmosis has several advantages over other technologies such as reverse osmosis, including reduced energy consumption, less fouling of the membrane, lower energy intensity due to the mild operating conditions (low pressure and operate at room temperature).

In some embodiments, the mechanically assisted forward osmosis is vibration assisted forward osmosis (VAFO). Vibration assisted forward osmosis can refer to a process that utilizes vibration assisted semipermeable membranes that reduce fouling in forward osmosis and enhance mixing. The shear stress may be generated on the membrane surface when the membranes are vibrating such as rotating disks, vibrating flat sheet membranes, or vibrating hollow fibers. See, for example, the Vibratory Shear Enhanced Process (VSEP) system (https://www.vsep.com/technology/system-components/). The application of shear stress may be utilized to induce boundary layer disturbance for mitigating concentration polarizing effects and controlling fouling.

In some embodiments, the mechanically assisted forward osmosis is turbulence assisted forward osmosis. Turbulence assisted forward osmosis can refer to a process that utilizes spinning technology, such as high-speed vortex generation, to reduce fouling in forward osmosis. In an embodiment, the vortex generators include rotating blades between the membrane surfaces which generate and maintain turbulent flows on the membrane surfaces. See, for example, the FMX system (https://bkt21.com/fmx).

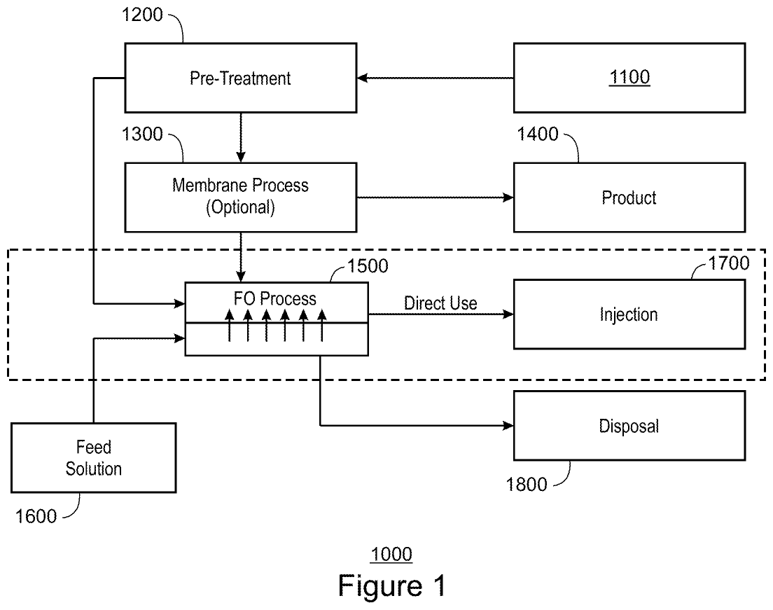

FIG. 1 depicts a flow diagram 1000 for a method for producing an injection water from a high salinity aqueous liquid. In step 1200, the high salinity aqueous liquid 1100 is pre-treated to remove solids and dissolved gas to produce a pre-treated aqueous liquid. In step 1500, the pre-treated aqueous liquid is used as a draw solution for mechanically assisted forward osmosis to produce an injection water. The draw solution is diluted with a feed solution 1600, which has a lower osmotic pressure than the high salinity aqueous liquid. In step 1700, the injection water is injected into an underground formation (e.g., a reservoir). In disposal step 1800, the liquid from the feed solution other than the fresh water extracted in the forward osmosis step 1500 to the injection side (1700) is disposed. For example, the disposal can be for brine, concentrated wastewater, or concentrated ground water after losing fresh water.

In certain embodiments, step 1300 includes passing the pre-treated aqueous liquid through a membrane process to produce desalinated water product 1400. In some embodiments, the membrane process comprises micro-filtration, ultra-filtration, nano-filtration, or reverse osmosis. In some embodiments, the membrane process comprises ultrahigh pressure reverse osmosis. These membrane processes have been found to be particularly effective for removing dissolved ions and organic solutes. These membrane processes use hydraulic pressure differences as a driving force. In an embodiment, the desalinated water 1400 can be used as desalter wash water. In certain embodiments, step 1300 is not included and the pre-treated aqueous liquid can be directly introduced to the mechanically assisted forward osmosis step 1500.

In the method disclosed herein, any combination of two different solutions with osmotic pressure can be utilized as the high salinity aqueous liquid 1100 (draw solution) and the feed solution 1600, provided that the feed solution has a lower osmotic pressure than the high salinity aqueous liquid 1100. In some embodiments, the high salinity aqueous liquid 1100 includes produced water. In some embodiments, the high salinity aqueous liquid 1100 includes ground water.

Feed solution 1600 can be any water resource which has a lower osmotic pressure than that of the high salinity aqueous liquid. In some embodiments, the feed solution 1600 comprises wastewater, brackish water, ground water, or a mixture thereof. In some embodiments, the brackish water is seawater. In an embodiment, the high salinity aqueous liquid 1100 is produced water and the feed solution is ground water or waste water. In an embodiment, the high salinity aqueous liquid 1100 is ground water and the feed solution is seawater.

The degree of pre-treatment performed in step 1200 can be tuned to the specifications required for injection, and additionally to minimize membrane fouling and maximize membrane performance. In certain embodiments, pre-treating step 1200 produces a pre-treated aqueous liquid having a mean suspended solid particle size of less than or equal to 5 micron. In certain embodiments, pre-treating step 1200 produces a pre-treated aqueous liquid having a mean suspended solid particle size of less than or equal to 2 micron. In certain embodiments, pre-treating step 1200 produces a pre-treated aqueous liquid having a maximum oil-in-water content of less than 20 ppm and maximum total oil and suspended solids (TSS) of less than 50 ppm.

In certain embodiments, pre-treating step 1200 includes the pre-treatment of ground water to produce pre-treated ground water. In some embodiments, the pre-treatment of ground water includes degassing, iron removal, and filtering.

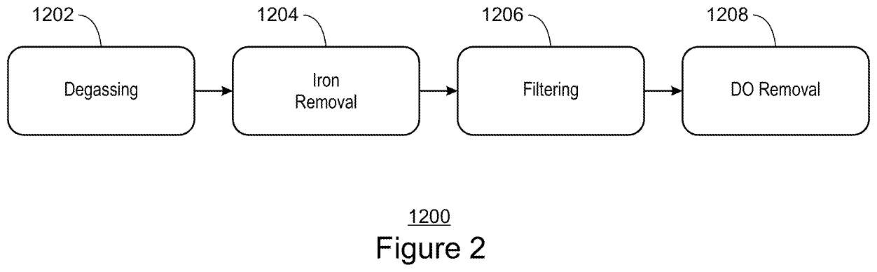

FIG. 2 depicts a flow diagram for an embodiment of a pre-treatment step 1200, where the pre-treatment includes the pre-treatment of ground water. In step 1202, the ground water is degassed. Gases that may be removed include nitrogen, carbon dioxide, methane, ethane, or combinations thereof. In some embodiments, on a dry basis, the associate gas composition is nitrogen (31.7%), CO₂ (21.1%), CH₄ (42.5%), and C₂H₆ (2.7%), which are removed in step 1202. In step 1204, iron is removed from the ground water. In some embodiments, the dissolved iron is oxidized to an insoluble compound. The insoluble compound may be removed along with the majority of inlet solids by the use of chemicals such as coagulants and flocculants. In some embodiments, the flocculated solids are allowed to settle under gravity (clarifier) or with the use of gas flotation (DAF and IGF processes). In some embodiments, step 1204 produces a liquid with a maximum iron content of 2 ppm (wt.). In step 1206, the ground water is filtered. In some embodiments, the filtering step 1206 produces a liquid with a maximum solids size of 2 μm. In step 1208, dissolved oxygen is removed. In some embodiments, step 1208 produces a liquid with an oxygen content at a level of 10 ppb (wt.) or less. In some embodiments, the pre-treatment step 1200 produces a pre-treated aqueous liquid with a maximum solids size of 2 μm, a maximum iron content of 2 ppm (wt.), and an oxygen content of 10 ppb (wt.) or less.

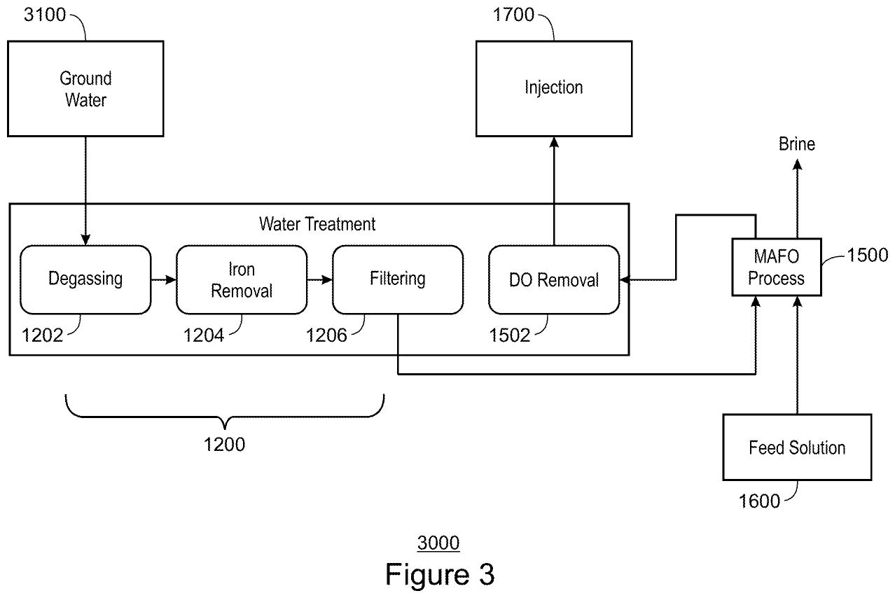

FIG. 3 depicts a flow diagram for an embodiment of a method 3000 for producing an injection water from ground water 3100. In step 1200, the ground water 3100 is pre-treated to remove solids and dissolved gas to produce a pre-treated ground water. In the embodiment shown in FIG. 3, pre-treatment step 1200 includes steps 1202, 1204, and 1206. In step 1202, the ground water is degassed. In step 1204, iron is removed from the ground water. In step 1206, the ground water is filtered. In step 1500, the pre-treated ground water is used as a draw solution for mechanically assisted forward osmosis to produce an injection water. The draw solution is diluted with a feed solution 1600. In the embodiment shown in FIG. 3, step 1502 includes removing dissolved oxygen from the injection water after the MAFO step 1500. In step 1700, the injection water is injected into an underground formation.

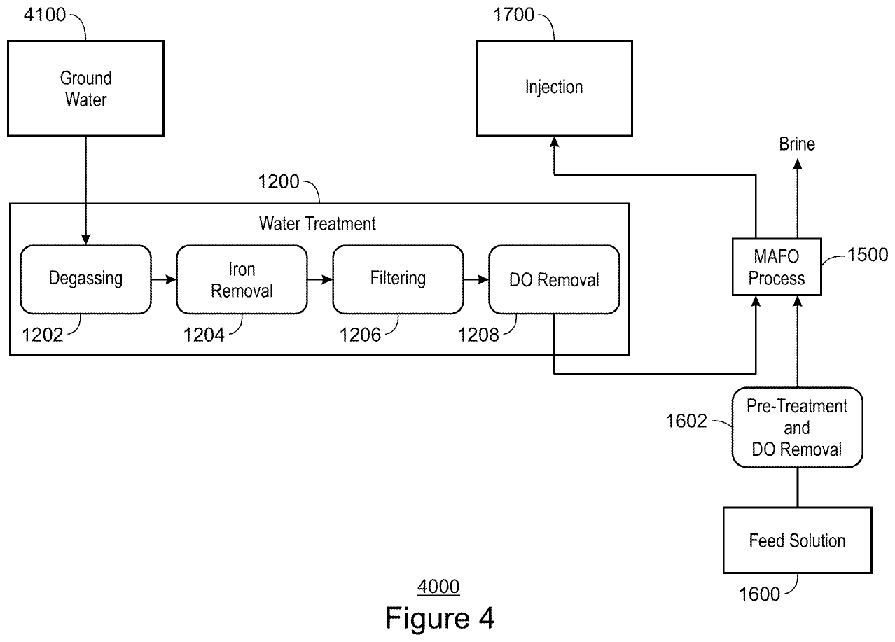

FIG. 4 depicts a flow diagram for an embodiment of a method 4000 for producing an injection water from ground water 4100. In step 1200, the ground water 4100 is pre-treated to remove solids and dissolved gas to produce a pre-treated ground water. In the embodiment shown in FIG. 4, pre-treatment step 1200 includes steps 1202, 1204, 1206, and 1208. In step 1202, the ground water is degassed. In step 1204, iron is removed from the ground water. In step 1206, the ground water is filtered. In step 1208, dissolved oxygen is removed from the ground water. In step 1500, the pre-treated ground water is used as a draw solution for mechanically assisted forward osmosis to produce an injection water. The draw solution is diluted with a feed solution 1600. In the embodiment shown in FIG. 4, step 1602 includes pre-treating and removing dissolved oxygen from the feed solution 1600 prior to the mechanically assisted forward osmosis step 1500. In step 1700, which occurs directly after mechanically assisted forward osmosis step 1500 in the embodiment shown in FIG. 4, the injection water is injected into an underground formation.

In certain embodiments, pre-treating step 1200 includes the pre-treatment of produced water to produce pre-treated produced water. In some embodiments, the pre-treatment step 1200 includes removing suspended solids. Suspended solids may be removed using sedimentation, filtration (bag filter, cartridge filter, cloth type filter and granular media filter), clarifier, floatation (e.g. dissolved air flotation (DAF) or induced air flotation (IAF)), screening, and/or Hydrocyclone.

In some embodiments, the pre-treatment of produced water includes removing dissolved oils. The oils may be removed by chemical treatment, gravity separation, parallel plate coalescers, gas flotation, cyclone separation, granular media filtration, and/or cartridge filtration. Emulsified oils can be removed by an adsorption process.

In some embodiments, the pre-treatment of produced water includes removing dissolved gas. The dissolved gas may include CO₂, hydrocarbons (methane, ethane, benzene, toluene, ethylbenzene and xylene), and/or H₂S. The dissolved gas may be removed by chemical treatment, gravity separation with coalescing devices, gas floatation, cyclonic separation, filtration, centrifuge separation, and/or packed bed degasification towers.

In some embodiments, the pre-treatment of produced water includes removing excess hardness by a chemical softening process.

In some embodiments, the pre-treated produced water has an oil-in-water water content of less than 20 ppm (wt. %) and a total oil and suspended solids of less than 50 ppm. In some embodiments, the pre-treating comprises treating the produced water with one or more of a De-sanding Hydrocyclone, a De-oiling Hydrocyclone, a Dissolved Gas Floatation (DGF) system, an Induced Gas Flotation (IGF) system, a Fine De-sanding Hydrocyclone, a Backwash Filter, a Nutshell Filter, a Multimedia Filter, CPI (corrugated plate interceptor), Membranes, Centrifuge, FWKO (free water knockout), CFU (compact flotation unit), and the like. In some embodiments, the pre-treating the produced water includes treating the produced water with one or more of a De-sanding Hydrocyclone, a De-oiling Hydrocyclone, a Dissolved Gas Floatation (DGF) system, an Induced Gas Flotation (IGF) system, a Fine De-sanding Hydrocyclone, and a Backwash Filter.

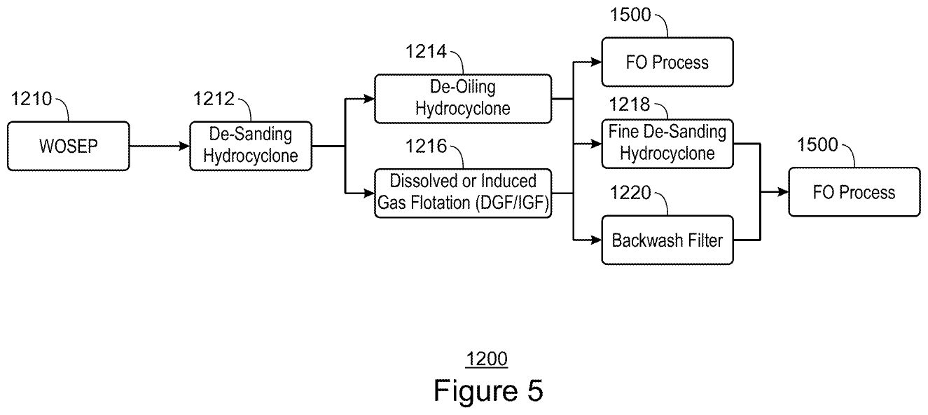

FIG. 5 depicts a flow diagram for embodiments of pre-treatment step 1200, where the pre-treatment includes the pre-treatment of produced water. In step 1210, the produced water is treated with a water-oil separator (WOSEP). In some embodiments, gas can be introduced from the bottom of the vessel to induce or provide more effective and fast separation of oil and water. In step 1212, the produced water is treated with a De-Sanding Hydrocyclone. In an embodiment, step 1214 includes treating the produced water with a De-oiling Hydrocyclone. In an embodiment, step 1216 includes treating the produced water to a dissolved gas flotation (DGF) or Induced Gas Floatation (IGF) system. In an embodiment, step 1218 includes treating the produced water with a Fine De-Sanding Hydrocyclone. In an embodiment, step 1220 includes treating the produced water with a Backwash Filter.

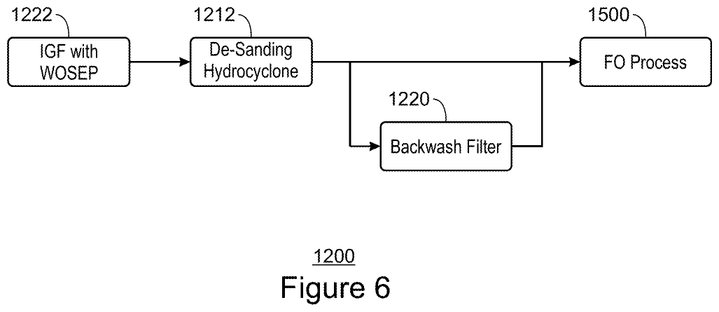

FIG. 6 depicts a flow diagram for embodiments of pre-treatment step 1200, where the pre-treatment includes the pre-treatment of produced water. Step 1222 includes treating the produced water to an Induced Gas Floatation (IGF) system with WOSEP. In some embodiments, gas can be introduced from the bottom of the vessel to induce or provide more effective and fast separation of oil and water. Step 1212 includes treating the produced water with a De-sanding hydrocyclone. Optional step 1220 includes treating the produced water with a Backwash Filter.

In some embodiments, the pre-treated aqueous liquid has an oil-in-water water content of less than 300 ppm (wt. %), less than 250 ppm, less than 200 ppm, less than 150 ppm, less than 100 ppm, less than 75 ppm, less than 50 ppm, less than 25 ppm, or less than 20 ppm. In some embodiments, the pre-treated aqueous liquid has an oil-in-water water content of less than 20 ppm (wt. %). In some embodiments, the pre-treated aqueous liquid has a total oil and suspended solids of less than 100 ppm, less than 75 ppm, or less than 50 ppm. In some embodiments, the pre-treated aqueous liquid has a total oil and suspended solids of less than 50 ppm. In some embodiments, the pre-treated aqueous liquid has an oil-in-water water content of less than 20 ppm (wt. %) and a total oil and suspended solids of less than 50 ppm.

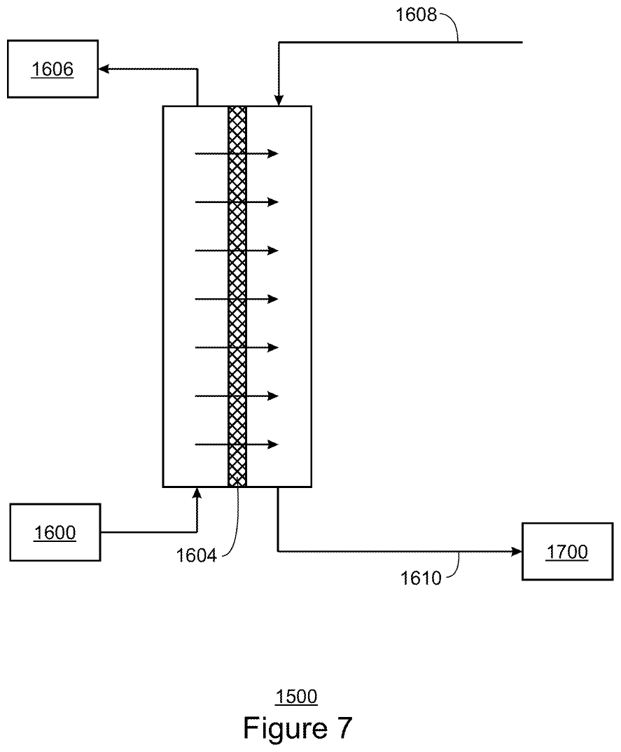

FIG. 7 depicts mechanically assisted forward osmosis step 1500. Feed solution 1600 and draw solution 1608 are introduced to a semi-permeable membrane 1604. The aqueous liquid flows from the low osmotic pressure side to the high osmotic pressure side to equalize the solute concentration, producing an injection water 1610 for injecting step 1700. In other words, water penetrates through the semi-permeable membrane 1604 from the low salinity side to the high osmotic pressure side due to the chemical potential difference. Feed solution 1600 is concentrated and the higher osmotic pressure liquid 1606 flows out and leaves the system to disposal or recirculation to the feed 1600 depending on the salinity (osmotic pressure). In some embodiments, liquid 1606 is disposed. For example, if the feed solution comprises brine (e.g. concentrated seawater), liquid 1606 may be disposed into the sea.

In some embodiments, the semi-permeable membrane 1604 has a planar geometry or a tubular geometry. In some embodiments, the semi-permeable membrane 1604 has a planar geometry, for example a flat sheet membrane. In some embodiments, the semi-permeable membrane 1604 has a tubular geometry, for example a hollow fiber membrane or a tubular membrane.

In some embodiments, the material of the semi-permeable membrane 1604 is a fully crosslinked aromatic polyamide, aquaporin, cellulose-based acetate, polybenzimidazole, polyoxadiazole, polyfurane, polyether-polyfurane, sulfonated polysulfone, polyvinylamine, polypiperazine-amide, or polypyrrolidine. In some embodiments, the fully crosslinked aromatic polyamide is a thin film composite prepared by an interfacial polymerization technique.

In some embodiments, the pre-treatment step 1200 produces an aqueous liquid that meets the manufacturer specifications of the semi-permeable membrane 1604 in order to protect the membrane and achieve optimal membrane performance.

In some embodiments, the injection water meets certain requirements to avoid adverse impacts on injection into an underground formation. The injection water specifications may vary depending on the site (e.g. reservoir). In some embodiments, the injection water has an oil-in-water content of less than 20 ppm (wt. %), a total oil and suspended solids of less than 50 ppm, and a mean suspended solid particle size of less than or equal to 5 micron. In some embodiments, the injection water has a mean suspended solid particle size of less than 2 micron, a dissolved oxygen content of less than 0.1 ppm, and an iron content of less than 2 ppm.

In some embodiments, the injection water is directly injected into the underground formation (step 1700) after the mechanically assisted forward osmosis step 1500. In some embodiments, the injection water can be injected into the underground formation without a regeneration step of draw solution. This is an advantage of the method disclosed herein because a regeneration step is an energy intensive process.

The method disclosed herein can provide a higher injection water volume than the original injection water sourced from ground water or produced water from WOSEP.

### Example 1: Model Predictive Control of Vibration Assisted Forward Osmosis

A process will be simulated with the following steps:
1. The TDS (total dissolved solids or concentration) of the feed solution at the outlet will be utilized to monitor any ingress of salts from the draw solution. If the feed TDS is high, then the feed stream (low TDS) flow rate will increase to reduce the outlet TDS of feed solution.
2. The TDS across the FO membrane for both draw and feed stream inlet and outlet will be monitored to measure and monitor the performance of the FO unit.
3. Water concentration (WC) or dilution degree in the draw solution from FO unit will be utilized to monitor the performance of the FO by increasing or decreasing the flow of the draw solution to FO. Further, WC will be utilized to measure the chemical concentration.

Multivariable Model Predictive Controllers:

The objective function of the controller is to maximize the water recovery while minimize concentration polarization and others.

Configure a Closed Loop Controller in Draw Solution Outlet where the Process Variable are:

Minimum TDS of the draw solution from the FO unit (high dilution of draw solution)

The Manipulated Variables are:
1. Feed solution TDS (Feed inlet), Temperature, Pressure, Flow
2. Draw solution TDS (Draw inlet), Temperature, Pressure, Flow
3. Concentrated feed solution TDS (Feed outlet), Temperature, Pressure, Flow and water concentration (WC)
4. Diluted draw solution TDS (draw outlet), Temperature, Pressure, Flow
5. Flow Control Valve (FCV) opening
6. Other variables such as intensity and frequency of vibration to FO cell(s)

Prediction models for the above process variables will be built using mechanistic model or by experiment during or by using the artificial intelligence of the historical data. Model predictive controller MPC (multi-variable controllers MVC) will be used to control to maximize water recovery. It will also be used to predict the performance of the unit and arrange for planned maintenance accordingly.

### Example 2: Pre-Treatment of Ground Water

Ground water, which has higher salinity (higher osmotic pressure) than the feed solution, can be treated for use as an injection water. Here, the feed solution can be any water sources which have lower osmotic pressure than groundwater. For example, the feed solution can be ground water, waste water, or sea water. For example, the feed solution is sea water. The ground water may contain dissolved gases such as hydrocarbons in the range of 0.1-2.0 SCF/bbl of gas water ratio. Gas is first removed from the water to atmospheric pressure in the degassing package, which consists of multiple degasser towers with fuel gas sparging for enhanced degassing efficiency. Off gas from the degassing towers can be flared or processed further in gas plant for recovery and monetization. Then in the downstream of the degassing package, the water will be treated by an iron removal package where iron oxidant (e.g. ClO₂ and/or NaOCl) will be used to oxidize and precipitate the iron. Coagulant and flocculant may be added to help coagulate and settle the precipitated solids in the clarifier. The required level of iron in the treated water must be less than 2 ppm. Then, multimedia filter and fine filter can be used to ensure particles bigger than 2 microns are removed before sending the water to the dissolved oxygen removal process. Finally, to minimize the corrosion, oxygen scavenger can be injected to reduce the dissolved oxygen level lower than 0.1 ppm. Through the process, HCl (hydrochloric acid) is injected to reduce pH and prevent precipitation of scale (CaCO₃).

What is claimed:

1. A method comprising:
pre-treating a high salinity aqueous liquid to remove solids, oil, and dissolved gases,
wherein the high salinity aqueous liquid comprises produced water or ground water;
using the pre-treated aqueous liquid as a draw solution for mechanically assisted forward osmosis to produce an injection water, wherein the draw solution is diluted with a feed solution, wherein the feed solution has a lower osmotic pressure than the high salinity aqueous liquid; and
injecting the injection water into an underground formation.

2. The method of claim 1, wherein the pre-treated aqueous liquid has a mean suspended particle size of less than or equal to 5 micron.

3. The method of claim 1, wherein the pre-treated aqueous liquid has a mean suspended solid particle size of less than or equal to 2 micron.

4. The method of claim 1, wherein the mechanically assisted forward osmosis is vibration assisted forward osmosis or turbulence assisted forward osmosis.

5. The method of claim 1, wherein the mechanically assisted forward osmosis is vibration assisted forward osmosis.

6. The method of claim 1, wherein the high salinity aqueous liquid comprises produced water.

7. The method of claim 1, wherein the pre-treated aqueous liquid has an oil-in-water content of less than 20 ppm (wt. %), and a total oil and suspended solids of less than 50 ppm.

8. The method of claim 6, wherein the pre-treating comprises treating the produced water with one or more of a De-sanding Hydrocyclone, a De-oiling Hydrocyclone, a Dissolved Gas Floatation (DGF) system, an Induced Gas Flotation (IGF) system, a Fine De-sanding Hydrocyclone, a Backwash Filter, a Nutshell Filter, a Multimedia Filter, CPI, Membranes, Centrifuge, FWKO, and CFU.

9. The method of claim 1, wherein the high salinity aqueous liquid comprises ground water.

10. The method of claim 1, wherein the pre-treating the high salinity aqueous liquid comprises degassing, iron removal, and filtering.

11. The method of claim 10, wherein the pre-treating the high salinity aqueous liquid further comprises dissolved oxygen removal.

12. The method of claim 10, further comprising removing dissolved oxygen from the injection water prior to the injecting.

13. The method of claim 9, wherein the injection water has a mean suspended solid particle size of less than 2 micron, a dissolved oxygen content of less than 0.1 ppm, and an iron content of less than 2 ppm.

14. The method of claim 1, wherein the feed solution comprises wastewater, brackish water, ground water, or a mixture thereof.

15. The method of claim 1, wherein the mechanically assisted forward osmosis utilizes a membrane having a planar geometry or a tubular geometry.

16. The method of claim 1, wherein the mechanically assisted forward osmosis utilizes a membrane material comprising fully crosslinked aromatic polyamide, aquaporin, cellulose-based acetate, polybenzimidazole, polyoxadiazole, polyfurane, polyether-polyfurane, sulfonated polysulfone, polyvinylamine, polypiperazine-amide, or polypyrrolidine.

17. The method of claim 16, wherein the fully crosslinked aromatic polyamide is a thin film composite prepared by an interfacial polymerization technique.

18. The method of claim 1, further comprising passing the pre-treated liquid through a membrane process to produce desalinated water.

19. The method of claim 18, wherein the membrane process comprises micro-filtration, ultra-filtration, nano-filtration, reverse osmosis, or ultrahigh pressure reverse osmosis.

20. The method of claim 1, wherein the injecting is performed directly after the mechanically assisted forward osmosis.
